(19) United States
(12) Patent Application Publication
(10) Pub. No.: US 2025/0019539 A1
(43) Pub. Date: Jan. 16, 2025

(54) RESIN TUBE

(71) Applicant: KANEKA CORPORATION, Osaka-shi (JP)

(72) Inventor: Tomoaki HASHIGUCHI, Settsu-shi (JP)

(73) Assignee: KANEKA CORPORATION, Osaka-shi (JP)

(21) Appl. No.: 18/714,319

(22) PCT Filed: Nov. 17, 2022
(86) PCT No.: PCT/JP2022/042730

§ 371 Date: May 29, 2024

(30) Foreign Application Priority Data
Dec. 3, 2021 (JP) 2021-196584

(51) Int. Cl. C08L 67/04; C08K 3/013; C08K 5/20

(52) U.S. Cl. CPC C08L 67/04; C08K 3/013; C08K 5/20; C08L 2203/18; C08L 2205/02

(57) ABSTRACT

A resin tube contains a poly(3-hydroxyalkanoate) resin. The poly(3-hydroxyalkanoate) resin includes at least one copolymer of 3-hydroxybutyrate units and other hydroxyalkanoate units. A polystyrene-equivalent weight-average molecular weight of the poly(3-hydroxyalkanoate) resin, as measured by gel permeation chromatography using a chloroform solvent, is from 30×10⁴ to 50×10⁴. In a molecular weight distribution of the poly(3-hydroxyalkanoate) resin, a proportion of a component having a weight-average molecular weight of 25×10⁴ or less is from 15 to 40 wt %.

### TECHNICAL FIELD

The present invention relates to a resin tube containing a poly(3-hydroxyalkanoate) resin.

### BACKGROUND ART

In recent years, separate collection and composting of raw garbage have been promoted especially in Europe, and plastic products that can be composted together with raw garbage have been desired. Additionally, marine pollution caused by microplastics has become an issue of great concern, and there is a demand for development of plastics degradable in seawater.

Poly(3-hydroxyalkanoate) resins are thermoplastic polyesters produced and accumulated as energy storage substances in the cells of many kinds of microorganisms. These resins are biodegradable in seawater as well as in soil and thus are attracting attention as materials that can be a solution to the above-mentioned problems.

Patent Literature 1 discloses a resin tube pliable and suitable for use as a straw. The disclosed resin tube is formed from a poly(3-hydroxyalkanoate) resin and has a wall thickness of 0.1 to 0.6 mm.

Patent Literature 2 discloses a resin composition containing a polyhydroxyalkanoate such as poly(3-hydroxy butyrate-co-3-hydroxyhexanoate) and low-melting-point polyhydroxy butyrate having a weight-average molecular weight of 5,000 to 50,000 and a melting point of 140 to 170° C. This resin composition is described as exhibiting an increased crystallization rate of the polyhydroxyalkanoate.

### CITATION LIST

### Patent Literature

PTL 1: WO 2020/040093

PTL 2: Japanese Laid-Open Patent Application Publication No. 2014-227543

### SUMMARY OF INVENTION

### Technical Problem

The technique disclosed in Patent Literature 1 can provide a pliable resin tube formed from a poly(3-hydroxy butyrate) resin. However, this technique could fail to achieve sufficient productivity or sufficient strength of the resin tube and has room for improvement.

The technique disclosed in Patent Literature 2 offers an increase in the crystallization rate of a poly(3-hydroxyalkanoate) resin. However, the resulting molded article tends to have poor mechanical properties. Patent Literature 2 neither describes nor suggests any resin tube.

In view of the above circumstances, the present invention aims to provide a resin tube containing a poly(3-hydroxyalkanoate) resin, having high strength, and producible by high-speed molding.

### Solution to Problem

As a result of intensive studies with the goal of solving the above problem, the present inventors have found that a resin tube having high strength and producible by high-speed molding can be formed when the weight-average molecular weight of a poly(3-hydroxyalkanoate) resin contained in the resin tube and the proportion of a low-molecular-weight component in the poly(3-hydroxyalkanoate) resin are set within given ranges. Based on this finding, the inventors have completed the present invention.

Specifically, the present invention relates to a resin tube containing a poly(3-hydroxyalkanoate) resin, wherein the poly(3-hydroxyalkanoate) resin includes at least one copolymer of 3-hydroxy butyrate units and other hydroxyalkanoate units, a polystyrene-equivalent weight-average molecular weight of the poly(3-hydroxyalkanoate) resin, as measured by gel permeation chromatography using a chloroform solvent, is from 30×10⁴ to 50×10⁴, and in a molecular weight distribution of the poly(3-hydroxyalkanoate) resin, a proportion of a component having a weight-average molecular weight of 25×10⁴ or less is from 15 to 40 wt %.

### Advantageous Effects of Invention

The present invention can provide a resin tube containing a poly(3-hydroxyalkanoate) resin, having high strength, and producible by high-speed molding.

### BRIEF DESCRIPTION OF DRAWINGS

FIG. 1 shows an example of a cumulative weight molecular weight distribution used to calculate the proportion of a low-molecular-weight component having a weight-average molecular weight of 25×10⁴ or less.

### DESCRIPTION OF EMBODIMENTS

Hereinafter, embodiments of the present invention will be described. The present invention is not limited to the embodiments described below.

One embodiment of the present invention relates to a resin tube containing a poly(3-hydroxyalkanoate) resin.

### Poly(3-hydroxyalkanoate) Resin

The poly(3-hydroxyalkanoate) resin (abbreviated as “P3HA”), which is a main resin component of the resin tube, is a polymer containing 3-hydroxyalkanoate structural units (monomer units). One poly(3-hydroxyalkanoate) resin may be used, or two or more poly(3-hydroxy alkanoate) resins may be used in combination.

Specifically, the 3-hydroxyalkanoate structural units are preferably structural units represented by the following formula (1).

—CHR—CH₂—CO—O— (1)

In the formula (1), R is an alkyl group represented by CₚH₂ₚ₊₁, and p is an integer from 1 to 15. Examples of R include linear or branched alkyl groups such as methyl, ethyl, propyl, methylpropyl, butyl, isobutyl, t-butyl, pentyl, and hexyl groups. The integer p is preferably from 1 to 10 and more preferably from 1 to 8.

The poly(3-hydroxyalkanoate) resin is particularly preferably a microbially produced poly(3-hydroxyalkanoate) resin. In the microbially produced poly(3-hydroxyalkanoate) resin, all of the 3-hydroxyalkanoate structural units are contained as (R)-3-hydroxyalkanoate structural units.

The poly(3-hydroxyalkanoate) resin preferably contains 50 mol % or more 3-hydroxyalkanoate structural units (in particular, the structural units represented by the formula (1)) in total structural units, and the content of the 3-hydroxyalkanoate structural units is more preferably 60 mol % or more and even more preferably 70 mol % or more. The poly(3-hydroxyalkanoate) resin may contain only one type or two or more types of 3-hydroxy alkanoate structural units as repeating units constituting the polymer or may contain other structural units (such as 4-hydroxyalkanoate structural units) in addition to the one type or two or more types of 3-hydroxyalkanoate structural units.

Specific examples of the poly(3-hydroxyalkanoate) resin include poly(3-hydroxy butyrate), poly(3-hydroxy butyrate-co-3-hydroxypropionate), poly(3-hydroxy butyrate-co-3-hydroxyvalerate) abbreviated as P3HB3HV, poly(3-hydroxy butyrate-co-3-hydroxyvalerate-3-hydroxyhexanoate), poly(3-hydroxy butyrate-co-3-hydroxyhexanoate) abbreviated as P3HB3HH, poly(3-hydroxy butyrate-co-3-hydroxy heptanoate), poly(3-hydroxy butyrate-co-3-hydroxy octanoate), poly(3-hydroxy butyrate-co-3-hydroxynonanoate), poly(3-hydroxy butyrate-co-3-hydroxy decanoate), poly(3-hydroxy butyrate-co-3-hydroxyundecanoate), and poly(3-hydroxy butyrate-co-4-hydroxy butyrate) abbreviated as P3HB4HB.

In the present embodiment, the poly(3-hydroxyalkanoate) resin includes at least one copolymer of 3-hydroxy butyrate (also referred to as “3HB” hereinafter) units and other hydroxyalkanoate units. The poly(3-hydroxyalkanoate) resin may include one such copolymer or may include two or more such copolymers. The poly(3-hydroxyalkanoate) resin may consist only of the at least one copolymer or may include poly(3-hydroxy butyrate), i.e., a homopolymer of 3-hydroxy butyrate, in addition to the at least one copolymer.

In terms of factors such as the resin tube productivity and the strength of the resin tube, the copolymer of 3-hydroxy butyrate units and other hydroxyalkanoate units is preferably at least one selected from the group consisting of poly(3-hydroxy butyrate-co-3-hydroxyvalerate), poly(3-hydroxy butyrate-co-3-hydroxy valerate-co-3-hydroxyhexanoate), poly(3-hydroxy butyrate-co-3-hydroxyhexanoate), and poly(3-hydroxy butyrate-co-4-hydroxy butyrate), more preferably poly(3-hydroxy butyrate-co-3-hydroxy hexanoate) and/or poly(3-hydroxy butyrate-co-4-hydroxy butyrate), and even more preferably poly(3-hydroxy butyrate-co-3-hydroxy hexanoate).

In terms of ensuring both the strength of the resin tube and the resin tube productivity, the average content ratio between 3-hydroxy butyrate units and other hydroxyalkanoate units (3-hydroxy butyrate units/other hydroxyalkanoate units) in the total poly(3-hydroxyalkanoate) resin contained in the resin tube is preferably from 95/5 to 82/18 (mol %/mol %), more preferably from 94/6 to 83/17 (mol %/mol %), and even more preferably from 93/7 to 84/16 (mol %/mol %).

The average content of certain monomer units in the total poly(3-hydroxyalkanoate) resin can be determined by a method known to those skilled in the art, such as a method described in paragraph [0047] of WO 2013/147139. The “average content” refers to the proportion of the monomer units in total monomer units contained in the total poly(3-hydroxyalkanoate) resin contained in the resin tube. When the poly(3-hydroxyalkanoate) resin is a mixture of two or more poly(3-hydroxyalkanoate) resins, the average content of certain monomer units refers to the proportion of the monomer units in the total mixture.

In the present embodiment, the weight-average molecular weight of the poly(3-hydroxyalkanoate) resin is controlled in the range of 30×10⁴ to 50×10⁴ to ensure both high strength of the resin tube and producibility of the resin tube by high-speed molding. If the weight-average molecular weight is less than 30×10⁴, the melt viscosity of the poly(3-hydroxyalkanoate) resin is extremely low; and continuous production of the resin tube by melt extrusion molding tends to be difficult. Even when continuous production by molding is possible, the resulting resin tube tends to have low strength. If the weight-average molecular weight is more than 50×10⁴, the melt viscosity of the poly(3-hydroxyalkanoate) resin is extremely high, and the resin tube tends to suffer from an appearance defect due to melt fracture. The weight-average molecular weight is preferably from 35×10⁴ to 48×10⁴, more preferably from 36×10⁴ to 46×10⁴, and even more preferably from 37×10⁴ to 45×10⁴.

The weight-average molecular weight of the poly(3-hydroxyalkanoate) resin is a weight-average molecular weight measured for the total poly(3-hydroxyalkanoate) resin contained in the resin tube. When the poly(3-hydroxyalkanoate) resin is a mixture of two or more poly(3-hydroxyalkanoate) resins, the weight-average molecular weight measured for the total mixture is in the above range. The weight-average molecular weight of each of the poly(3-hydroxyalkanoate) resins contained in the mixture is not limited to a particular range.

The weight-average molecular weight of the poly(3-hydroxyalkanoate) resin can be measured as a polystyrene-equivalent molecular weight by gel permeation chromatography using a chloroform solvent. The column used in the gel permeation chromatography may be any suitable column for weight-average molecular weight measurement.

Furthermore, in the present embodiment, the proportion of a low-molecular-weight component having a weight-average molecular weight of 25×10⁴ or less in a molecular weight distribution of the poly(3-hydroxyalkanoate) resin is controlled in the range of 15 to 40 wt % to ensure both high strength of the resin tube and producibility of the resin tube by high-speed molding. If the proportion of the low-molecular-weight component is less than 15 wt %, the molding speed in production of the resin tube tends to decline. If the proportion of the low-molecular-weight component is more than 40 wt %, the resin tube tends to have low strength. The proportion of the low-molecular-weight component is preferably from 18 to 35 wt % and more preferably from 20 to 30 wt %.

The proportion of the low-molecular-weight component is that measured for the total poly(3-hydroxyalkanoate) resin contained in the resin tube. When the poly(3-hydroxyalkanoate) resin is a mixture of two or more poly(3-hydroxyalkanoate) resins, the proportion of the low-molecular-weight component, as measured for the total mixture, is in the above range. The proportion of the low-molecular-weight component in each of the poly(3-hydroxyalkanoate) resins contained in the mixture is not limited to a particular range.

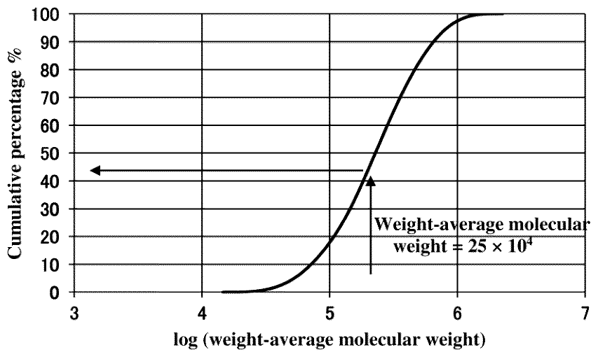

The proportion of the low-molecular-weight component can be determined as follows: the weight-average molecular weight distribution obtained through the above-mentioned weight-average molecular weight measurement is converted to a cumulative weight molecular weight distribution as shown in FIG. 1; and the proportion of the low-molecular-weight component having a weight-average molecular weight of 25×10⁴ or less in the total amount is calculated from the cumulative distribution. To eliminate the influence of other components such as additives, the weight-average molecular weight region up to 1000 is excluded from the calculation.

The method for obtaining the poly(3-hydroxyalkanoate) resin meeting the above-described requirements concerning the weight-average molecular weight and the proportion of the low-molecular-weight component is not limited to using a particular technique, and any known technique for molecular weight adjustment of polyesters can be used. An exemplary method is to mix two or more poly(3-hydroxyalkanoate) resins having different molecular weights.

A specific example of the method is to blend a high-molecular-weight poly(3-hydroxyalkanoate) resin having a weight-average molecular weight of 40×10⁴ to 80×10⁴ (preferably 45×10⁴ to 75×10⁴, more preferably 50×10⁴ to 70×10⁴) and a low-molecular-weight poly(3-hydroxyalkanoate) resin having a weight-average molecular weight of 10×10⁴ to 40×10⁴ (preferably 12×10⁴ to 35 10⁴, more preferably 15×10⁴ to 30×10⁴) and adjust the weight-average molecular weight of the total blend and the proportion of the low-molecular-weight component in the total blend.

The proportions in which the high-molecular-weight poly(3-hydroxyalkanoate) resin and the low-molecular-weight poly(3-hydroxyalkanoate) resin are used may be set as appropriate. For example, the weight ratio between the high-molecular-weight and low-molecular-weight poly(3-hydroxyalkanoate) resins is preferably from 50:50 to 95:5, more preferably from 60:40 to 90:10, and even more preferably from 65:35 to 85:15.

In a preferred aspect of the present embodiment, the poly(3-hydroxyalkanoate) resin forming the resin tube may include at least two poly(3-hydroxyalkanoate) resins differing in the types and/or contents of the constituent monomers.

In this aspect, it is particularly preferable for the poly(3-hydroxyalkanoate) resin forming the resin tube to include at least one high-crystallinity poly(3-hydroxyalkanoate) resin (A) and at least one low-crystallinity poly(3-hydroxyalkanoate) resin (B). In general, the high-crystallinity poly(3-hydroxyalkanoate) resin (A) is superior in terms of productivity but has low mechanical strength, while the low-crystallinity poly(3-hydroxyalkanoate) resin (B) has good mechanical properties although being inferior in terms of productivity. When these resins are used in combination, it is expected that the high-crystallinity poly(3-hydroxyalkanoate) resin (A) forms fine resin crystal grains and the low-crystallinity poly(3-hydroxyalkanoate) resin (B) forms tie molecules that cross-link the resin crystal grains to one another. The combined use can improve the resin tube productivity and provide marked enhancement of the strength of the resin tube.

When the high-crystallinity poly(3-hydroxyalkanoate) resin (A) contains 3-hydroxy butyrate units, the content of the 3-hydroxy butyrate units in the high-crystallinity poly(3-hydroxyalkanoate) resin (A) is preferably higher than the average content of 3-hydroxy butyrate units in total monomer units constituting the poly(3-hydroxyalkanoate) resin contained in the resin tube.

When the high-crystallinity poly(3-hydroxyalkanoate) resin (A) contains 3-hydroxy butyrate units and other hydroxyalkanoate units, the content of the other hydroxyalkanoate units in the high-crystallinity resin (A) is preferably from 1 to 6 mol % and more preferably from 2 to 6 mol %.

The high-crystallinity poly(3-hydroxyalkanoate) resin (A) is preferably poly(3-hydroxy butyrate-co-3-hydroxyhexanoate) or poly(3-hydroxy butyrate-co-4-hydroxy butyrate) and more preferably poly(3-hydroxy butyrate-co-3-hydroxyhexanoate).

The weight-average molecular weight of the high-crystallinity poly(3-hydroxyalkanoate) resin (A) is not limited to a particular range and may be set such that the weight-average molecular weight of the total poly(3-hydroxyalkanoate) resin contained in the resin tube and the proportion of the low-molecular-weight component in the total resin meet the above-described requirements. In terms of enhancing the strength of the resin tube, the high-crystallinity poly(3-hydroxyalkanoate) resin (A) preferably includes a poly(3-hydroxyalkanoate) resin having a relatively low weight-average molecular weight. More preferably, the high-crystallinity poly(3-hydroxyalkanoate) resin (A) includes both a poly(3-hydroxyalkanoate) resin having a relatively low weight-average molecular weight and a poly(3-hydroxyalkanoate) resin having a relatively high weight-average molecular weight.

When the low-crystallinity poly(3-hydroxyalkanoate) resin (B) contains 3-hydroxy butyrate units, the content of the 3-hydroxy butyrate units in the low-crystallinity poly(3-hydroxyalkanoate) resin (B) is preferably lower than the average content of 3-hydroxy butyrate units in total monomer units constituting the poly(3-hydroxyalkanoate) resin contained in the resin tube.

When the low-crystallinity poly(3-hydroxyalkanoate) resin (B) contains 3-hydroxy butyrate units and other hydroxyalkanoate units, the content of the other hydroxyalkanoate units in the low-crystallinity resin (B) is preferably from 24 to 99 mol %, more preferably from 24 to 50 mol %, even more preferably from 24 to 35 mol %, and particularly preferably from 24 to 30 mol %.

The low-crystallinity poly(3-hydroxyalkanoate) resin (B) is preferably poly(3-hydroxy butyrate-co-3-hydroxyhexanoate) or poly(3-hydroxy butyrate-co-4-hydroxy butyrate) and more preferably poly(3-hydroxy butyrate-co-3-hydroxyhexanoate).

The weight-average molecular weight of the low-crystallinity poly(3-hydroxyalkanoate) resin (B) is not limited to a particular range and may be set such that the weight-average molecular weight of the total poly(3-hydroxyalkanoate) resin contained in the resin tube and the proportion of the low-molecular-weight component in the total resin meet the above-described requirements. In terms of enhancing the strength of the resin tube, the low-crystallinity poly(3-hydroxyvalkanoate) resin (B) preferably has a relatively high weight-average molecular weight. Specifically, the weight-average molecular weight of the low-crystallinity poly(3-hydroxyalkanoate) resin (B) is preferably from 40×10⁴ to 80×10⁴. more preferably from 45×10⁴ to 75×10⁴, and even more preferably from 50×10⁴ to 70×10⁴.

When the high-crystallinity poly(3-hydroxyalkanoate) resin (A) and the low-crystallinity poly(3-hydroxyalkanoate) resin (B) are used in combination, the proportion of each resin in the total amount of the two resins is not limited to a particular range. Preferably, the proportion of the resin (A) is from 60 to 97 wt % and the proportion of the resin (B) is from 3 to 40 wt %. When the proportion of the low-crystallinity poly(3-hydroxyalkanoate) resin (B) is 3 wt % or more, the strength of the resin tube can be sufficiently enhanced. When the proportion of the low-crystallinity poly(3-hydroxyalkanoate) resin (B) is 40 wt % or less, continuous production of the resin tube by melt extrusion molding tends to be easy. More preferably, the proportion of the resin (A) is from 65 to 95 wt % and the proportion of the resin (B) is from 5 to 35 wt %. Even more preferably, the proportion of the resin (A) is from 70 to 90 wt % and the proportion of the resin (B) is from 10 to 30 wt %.

The method for producing the poly(3-hydroxyalkanoate) resin is not limited to using a particular technique, and may be a production method using chemical synthesis or a microbial production method. A microbial production method is preferred. The microbial production method used can be any known method. Known examples of bacteria that produce copolymers of 3-hydroxy butyrate with other hydroxyalkanoates include Aeromonas caviae which is a P3HB3HV-and P3HB3HH-producing bacterium and Alcaligenes eutrophus which is a P3HB4HB-producing bacterium. In particular, in order to increase the P3HB3HH productivity, Alcaligenes eutrophus AC32 (FERM BP-6038; see T. Fukui, Y. Doi, J. Bacteriol., 179, pp. 4821-4830 (1997)) having a P3HA synthase gene introduced is more preferred. Such a microorganism is cultured under suitable conditions to allow the microorganism to accumulate P3HB3HH in its cells, and the microbial cells accumulating P3HB3HH are used. Instead of the above microorganism, a genetically modified microorganism having any suitable poly(3-hydroxyalkanoate) resin synthesis-related gene introduced may be used depending on the poly(3-hydroxyalkanoate) resin to be produced. The culture conditions including the type of the substrate may be optimized depending on the poly(3-hydroxyalkanoate) resin to be produced. Through these procedures, the content of 3-hydroxy butyrate units in the poly(3-hydroxyalkanoate) resin can be adjusted.

### Another Resin

The resin component contained in the resin tube may consist only of the poly(3-hydroxyalkanoate) resin or may further include another resin that is not classified as a poly(3-hydroxyalkanoate) resin. Examples of the other resin include: aliphatic polyester resins such as polylactic acid, polybutylene succinate adipate, polybutylene succinate, and polycaprolactone; and aliphatic-aromatic polyester resins such as polybutylene adipate terephthalate, poly butylene sebacate terephthalate, and polybutylene azelate terephthalate. The resin component may include only one such other resin or two or more such other resins.

The amount of the other resin is not limited to a particular range, but is preferably small in terms of the seawater degradability of the resin tube. Specifically, the amount of the other resin is preferably 35 parts by weight or less, more preferably 30 parts by weight or less, even more preferably 20 parts by weight or less, and still even more preferably 10 parts by weight or less per 100 parts by weight of the poly(3-hydroxyalkanoate) resin. The lower limit of the amount of the other resin is not limited to a particular value and may be (part by weight.

### Inorganic Filler

The resin tube need not contain any inorganic filler, but preferably contains an inorganic filler in terms of enhancing the strength of the resin tube.

The inorganic filler is not limited to a particular type and may be any inorganic filler that can be used in the resin tube. Examples of the inorganic filler include: silica-based inorganic fillers such as quartz, fumed silica, silicic anhydride, molten silica, crystalline silica, amorphous silica, a filler obtained by condensation of alkoxysilane, and ultrafine amorphous silica; and other inorganic fillers such as alumina, zircon, iron oxide, zinc oxide, titanium oxide, silicon nitride, boron nitride, aluminum nitride, silicon carbide, glass, silicone rubber, silicone resin, titanium oxide, carbon fiber, mica, black lead, carbon black, ferrite, graphite, diatomite, white clay, clay, talc, calcium carbonate, manganese carbonate, magnesium carbonate, barium sulfate, and silver powder. One of these fillers may be used alone, or two or more thereof may be used in combination.

The inorganic filler may be surface-treated in order to increase its dispersibility in the resin tube. Examples of the treatment agent used for the surface treatment include higher fatty acids, silane coupling agents, titanate coupling agents, sol-gel coating agents, and resin coating agents.

The water content of the inorganic filler is preferably from 0.01 to 10%, more preferably from 0.01 to 5%, and even more preferably from 0.01 to 1% in order to reliably inhibit hydrolysis of the poly(3-hydroxyalkanoate) resin. The water content can be determined according to JIS K 5101.

The average particle size of the inorganic filler is preferably from 0.1 to 100 μm, more preferably from 0.1 to 50 μm, even more preferably from 0.1 to 30 μm, and particularly preferably from 0.1 to 15 μm in order to ensure good properties and high processability of the resin tube. The average particle size can be measured using a laser diffraction/scattering particle size analyzer such as “Microtrac MT3100II” manufactured by Nikkiso Co., Ltd.

Among inorganic fillers, those belonging to silicate salts are preferred since such fillers can provide an increase in heat resistance and improvement in processability. Among silicate salts, at least one selected from the group consisting of talc, mica, kaolinite, montmorillonite, and smectite is preferred since these silicate salts provide significant enhancement of the strength of the resin tube and have such a narrow particle size distribution as to cause less deterioration in surface smoothness and mold surface transferability. Two or more silicate salts may be used in combination and, in this case, the types and proportions of the silicate salts can be adjusted as appropriate.

Examples of the talc include general-purpose talc and surface-treated talc, specific examples of which include “MICRO ACE™” manufactured by Nippon Talc Co., Ltd., “Talcum powder™” manufactured by Hayashi Kasei Co., Ltd., and talc manufactured by Takehara Kagaku Kogyo Co., Ltd. or Maruo Calcium Co., Ltd.

Examples of the mica include wet-ground mica and dry-ground mica, specific examples of which include mica manufactured by Yamaguchi Mica Co., Ltd. or Keiwa Rozai Co., Ltd.

Examples of the kaolinite include dry kaolin, calcined kaolin, and wet kaolin, specific examples of which include “TRANSLINK™”, “ASP™”, “SANTINTONE™”, and “ULTREX™” manufactured by Hayashi Kasei Co., Ltd. and kaolinite manufactured by Keiwa Rozai Co., Ltd.

When the resin tube contains an inorganic filler as described above, the amount of the inorganic filler is preferably from 1 to 30 parts by weight per 100 parts by weight of the total resin component including the poly(3-hydroxyalkanoate) resin in terms of enhancing the strength of the resin tube and ensuring the fluidity of the resin component during melt molding. The amount of the inorganic filler is more preferably from 5 to 25 parts by weight.

### Additives

The resin tube may contain additives other than inorganic fillers to the extent that the additives do not diminish the effect of the invention. Examples of the additives include a nucleating agent, a lubricant, a plasticizer, an antistatic, a flame retardant, a conductive additive, a heat insulator, a crosslinking agent, an antioxidant, an ultraviolet absorber, a colorant, an organic filler, and a hydrolysis inhibitor, and these additives can be used depending on the intended purpose. Biodegradable additives are particularly preferred.

Examples of the nucleating agent include pentaerythritol, orotic acid, aspartame, cyanuric acid, glycine, zinc phenylphosphonate, and boron nitride. Poly(3-hydroxybutyrate) can also be added as the nucleating agent. Among the mentioned compounds, pentaerythritol is preferred because it is particularly superior in the accelerating effect on crystallization of the poly(3-hydroxyalkanoate) resin. One nucleating agent may be used alone, or two or more nucleating agents may be mixed. The mix proportions of the nucleating agents can be adjusted as appropriate depending on the intended purpose. The resin tube need not contain any nucleatingagent (in particular, pentaery thritol).

When a nucleating agent other than poly(3-hydroxy butyrate) is used, the amount of the nucleating agent is not limited to a particular range, but is preferably from 0.1 to 10 parts by weight, more preferably from 0.5 to 8.5 parts by weight, even more preferably from 0.7 to 6 parts by weight, and particularly preferably from 0.8 to 3 parts by weight per 100 parts by weight of the poly(3-hydroxyalkanoate) resin. When poly(3-hydroxy butyrate) is added as a nucleating agent, the amount of the poly(3-hydroxy butyrate) is not limited to a particular range, but is preferably from 0.1 to 15 parts by weight, more preferably from 1 to 10 parts by weight, even more preferably from 3 to 8 parts by weight, and particularly preferably from 4 to 7 parts by weight per 100 parts by weight of the poly(3-hydroxyalkanoate) resin exclusive of the poly(3-hydroxy butyrate).

Examples of the lubricant include behenamide, oleamide, erucamide, stearamide, palmitamide, N-stearyl behenamide, N-stearyl erucamide, ethylenebisstearamide, ethylenebisoleamide, ethy lenebiserucamide, ethylenebislauramide, ethylenebiscapramide, p-phenylenebisstearamide, and a polycondensation product of ethylenediamine, stearic acid, and sebacic acid. Among these, behenamide and erucamide are preferred because they are particularly superior in the lubricating effect on the poly(3-hydroxyalkanoate) resin. One lubricant may be used alone, or two or more lubricants may be mixed. The mix proportions of the lubricants can be adjusted as appropriate depending on the intended purpose.

The amount of the lubricant used is not limited to a particular range, but is preferably from 0.01 to 5 parts by weight, more preferably from 0.05 to 3 parts by weight, and even more preferably from 0.1 to 1.5 parts by weight per 100 parts by weight of the poly(3-hydroxy alkanoate) resin.

Examples of the plasticizer include glycerin ester compounds, citric ester compounds, sebacic ester compounds, adipic ester compounds, polyether ester compounds, benzoic ester compounds, phthalic ester compounds, isosorbide ester compounds, polycaprolactone compounds, and dibasic ester compounds. Among these, glycerin ester compounds, citric ester compounds, sebacic ester compounds, and dibasic ester compounds are preferred because they are particularly superior in the plasticizing effect on the poly(3-hydroxyalkanoate) resin. Examples of the glycerin ester compounds include glycerin diacetomonolaurate. Examples of the citric ester compounds include tributyl acetylcitrate. Examples of the sebacic ester compounds include dibutyl sebacate. Examples of the dibasic ester compounds include benzyl methyl diethylene glycol adipate. One plasticizer may be used alone, or two or more plasticizers may be mixed. The mix proportions of the plasticizers can be adjusted as appropriate depending on the intended purpose.

The amount of the plasticizer used is not limited to a particular range, but is preferably from 0 to 20 parts by weight, more preferably from 0 to 15 parts by weight, even more preferably from 0 to 10 parts by weight, and particularly preferably from 0 to 5 parts by weight per 100 parts by weight of the total resin component including the poly(3-hydroxyalkanoate) resin.

### Resin Tube

The term “tube” as used herein refers to a hollow; slender cylindrical molded article having a wall that has a generally constant thickness and that is generally circular in cross-section. The tube can be used as, but is not limited to, a straw or pipe.

In the case where the resin tube is used as a straw; the wall thickness of the resin tube is preferably from 0.01 to 0.6 mm, more preferably from 0.05 to 0.5 mm, and even more preferably from 0.1 to 0.4 mm so that the straw may avoid collapsing when a beverage is sucked through the straw, that the straw may be flexible enough to resist being broken, that the straw may cause little injury when its end contacts a fingertip, and that the straw may be quickly biodegraded in seawater.

In the case where the resin tube is used as a straw, the outer diameter of the resin tube is not limited to a particular range. In terms of the ease of use of the straw for drinking a beverage, the outer diameter is preferably from 2 to 10 mm, more preferably from 4 to 8 mm, and even more preferably from 5 to 7 mm.

In the case where the resin tube is used as a pipe, the wall thickness of the resin tube can be set as appropriate by those skilled in the art. The wall thickness is preferably from 0.7 to 10 mm and more preferably from 1 to 8 mm. The pipe is suitable for use in cultivation or catching of seafood products.

The resin tube is generally circular in cross-section. The cross-sectional shape is preferably close to a true circle in terms of the usability of the resin tube as a straw or pipe. Thus, the degree of flattening of the cross-sectional shape of the tube, calculated by the formula [100×(maximum outer diameter−minimum outer diameter)/maximum outer diameter], is preferably 10% or less, more preferably 8% or less, even more preferably 5% or less, and still even more preferably 3% or less. When the degree of flattening is 0%, this means that the cross-sectional shape is a true circle.

The length of the resin tube is not limited to a particular range. In the case where the resin tube is used as a straw, the length of the resin tube is preferably from 50 to 350 mm, more preferably from 70 to 300 mm, and even more preferably from 90 to 270 mm in terms of the ease of use of the straw for drinking a beverage.

The resin tube used as a straw may be a tube that has not been subjected to any secondary process or a tube that has been subjected to a secondary process such as formation of a stopper portion or corrugated portion. The secondary process may be performed under heating of the resin tube, but is preferably performed at normal temperature.

### Method for Producing Resin Tube

Hereinafter, an example of the method for producing the resin tube will be described in detail.

First, the poly(3-hydroxyalkanoate) resin including at least one copolymer of 3-hydroxy butyrate units and other hydroxyalkanoate units is melted and kneaded, together with another resin, an inorganic filler, and other additives added as necessary, by using a device such as an extruder, a kneader, a Banbury mixer, or a roll mill, and thus a resin composition is prepared. The resin composition is extruded into a strand, which is then cut to obtain pellets in the form of cylindrical, elliptic cylindrical, spherical, cubic, or rectangular parallelepiped-shaped particles. Desirably, the pellets thus made are thoroughly dried at 40 to 80° C. to remove water before they are subjected to tube molding.

The temperature for the melting and kneading depends on the properties such as melting point and melt viscosity of the resins used and cannot be definitely specified. The resin temperature of the melted kneaded product at the die outlet is preferably from 140 to 190° C., more preferably from 145 to 185° C., and even more preferably from 150 to 180° C. When the resin temperature of the melted kneaded product is 140° C. or higher, the resin component including the poly(3-hydroxyalkanoate) resin can be sufficiently melted. When the resin temperature is 190° C. or lower, thermal decomposition of the resin component including the poly(3-hydroxyalkanoate) resin can be prevented.

Next, the pellets made as above are melted in an extruder, and then the molten material is extruded from an annular die coupled to the outlet of the extruder. The extrudate is placed into water and thus solidified into the shape of a tube. Alternatively, a blend of the components may be melted in an extruder, and the molten blend may be directly formed into the shape of a tube without pelletization.

In the following items, preferred aspects of the present disclosure are listed. The present invention is not limited to the following items.

### Item 1

A resin tube containing a poly(3-hydroxyalkanoate) resin, wherein
the poly(3-hydroxyalkanoate) resin includes at least one copolymer of 3-hydroxy butyrate units and other hydroxyalkanoate units,
a polystyrene-equivalent weight-average molecular weight of the poly(3-hydroxyalkanoate) resin, as measured by gel permeation chromatography using a chloroform solvent, is from 30×10⁴ to 50×10⁴, and
in a molecular weight distribution of the poly(3-hydroxyalkanoate) resin, a proportion of a component having a weight-average molecular weight of 25×10⁴ or less is from 15 to 40 wt %.

### Item 2

The resin tube according to item 1, wherein the copolymer of 3-hydroxy butyrate units and other hydroxyalkanoate units is at least one selected from the group consisting of poly(3-hydroxy butyrate-co-3-hydroxyvalerate), poly(3-hydroxy butyrate-co-3-hydroxyvalerate-co-3-hydroxyhexanoate), poly(3-hydroxy butyrate-co-3-hydroxyhexanoate), and poly(3-hydroxy butyrate-co-4-hydroxy butyrate).

### Item 3

The resin tube according to item 1, wherein the copolymer of 3-hydroxybutyrate units and other hydroxyalkanoate units is poly(3-hydroxybutyrate-co-3-hydroxyhexanoate).

### Item 4

The resin tube according to any one of items 1 to 3, wherein the poly(3-hydroxyalkanoate) resin includes:
a copolymer (A) which is a copolymer of 3-hydroxy butyrate units and other hydroxyalkanoate units and in which a content of the other hydroxyalkanoate units is from 1 to 6 mol %; and
a copolymer (B) which is a copolymer of 3-hydroxy butyrate units and other hydroxyalkanoate units and in which a content of the other hydroxyalkanoate units is 24 mol % or more.

### Item 5

The resin tube according to any one of items 1 to 4, wherein a weight-average molecular weight of the copolymer (B) is from 40×10⁴ to 80×10⁴.

### Item 6

The resin tube according to any one of items 1 to 5, wherein an amount of a resin other than the poly(3-hydroxyalkanoate) resin is from 0 to 35 parts by weight per 100 parts by weight of the poly(3-hydroxyalkanoate) resin.

### Item 7

The resin tube according to any one of items 1 to 6, further containing a nucleating agent and/or a lubricant.

### Item 8

The resin tube according to any one of items 1 to 7, further containing 1 to 30 parts by weight of an inorganic filler per 100 parts by weight of a total resin component including the poly(3-hydroxyalkanoate) resin.

### Item 9

The resin tube according to any one of items 1 to 8, wherein a wall thickness of the resin tube is from 0.01 to 0.6 mm.

### Item 10

The resin tube according to any one of items 1 to 9, wherein a wall thickness of the resin tube is from 0.7 to 10 mm.

### EXAMPLES

Hereinafter, the present invention will be specifically described using examples. The technical scope of the present invention is not limited by the examples given below.

Listed below are materials used in Examples and Comparative Examples.

### Poly(3-hydroxyalkanoate) Resins

$$PHA - 1 : P 3 HB 3 HH \text{} ( average content ratio 3 HB / 3 HH = 95.4 / 4.6 ( mol \% / mol \% ) , weight - average molecular weight = 25 \times {10}^{4} g / mol )$$

This resin was produced according to a method described in Example 2 of WO 2019/142845.

$$PHA - 2 : P 3 HB 3 HH \text{} ( average content ratio 3 HB / 3 HH = 95.4 / 4.6 ( mol \% / mol \% ) , weight - average molecular weight = 55 \times {10}^{4} g / mol )$$

This resin was produced according to the method described in Example 2 of WO 2019/142845.

$$PHA - 3 : P 3 HB 3 HH \text{} ( average content ratio 3 HB / 3 HH = 95.4 / 4.6 ( mol \% / mol \% ) , weight - average molecular weight = 15 \times {10}^{4} g / mol )$$

This resin was produced according to the method described in Example 2 of WO 2019/142845.

$$PHA - 4 : P 3 HB 3 HH \text{} ( average content ratio 3 HB / 3 HH = 71.8 / 28.2 ( mol \% / mol \% ) , weight - average molecular weight = 66 \times {10}^{4} g / mol )$$

This resin was produced according to a method described in Example 9 of WO 2019/142845.

$$PHA - 5 : X 131 A ( Kaneka Biodegradable Polymer PHBH™ , average content ratio 3 HB / 3 HH = 94 / 6 ( mol \% / mol \% ) , weight - average molecular weight = 60 \times {10}^{4} g / mol )$$

### Additives

Additive-1: Polyhydroxybutyrate (weight-average molecular weight=30×10⁴ g/mol)

This additive was produced according to a method described in Comparative Example 1 of WO 2004/041936.

Additive-2: Behenamide (BNT-22H, manufactured by Nippon Fine Chemical Co., Ltd.)

Additive-3: Erucamide (NEUTRON-S, manufactured by Nippon Fine Chemical Co., Ltd.)

The following describes evaluation methods used in Examples and Comparative Examples.

### Method for Measuring Weight-Average Molecular Weight of Poly(3-hydroxyalkanoate) Resin before Blending

The weight-average molecular weight of each poly(3-hydroxyalkanoate) resin before blending was measured as follows. First, the poly(3-hydroxyalkanoate) resin was allowed to stand in chloroform at 60° C. for 30 minutes, after which the chloroform was stirred for another 30 minutes to dissolve the poly(3-hydroxyalkanoate) resin. The resulting solution was filtered through a disposable filter made of PTFE and having a pore size of 0.45 μm. Subsequently, the filtrate was subjected to GPC analysis under the conditions listed below, and thus the weight-average molecular weight was determined. The results are shown in Table 1.
GPC system: RI monitor (L-3000) manufactured by Hitachi
Columns: K-G (one column) and K-806 L (two columns) manufactured by Showa Denko K.K.
Sample concentration: 3 mg/ml
Eluent: Chloroform solvent
Eluent flow rate: 1.0 ml/min
Sample injection amount: 100 μL
Analysis time: 30 minutes
Standard sample: Polystyrene

### Method for Measuring Weight-Average Molecular Weight of Poly(3-hydroxyalkanoate) Resin after Compounding

The weight-average molecular weight of each of the poly(3-hydroxyalkanoate) resins resulting from compounding in Examples and Comparative Examples was measured by a method identical to that described above in “Method for Measuring Weight-Average Molecular Weight of Poly(3-hydroxyalkanoate) Resin before Blending”, except that the poly(3-hydroxyalkanoate) resins were used in the form of pellets as described later and that insoluble substances were removed by centrifugation before filtration through a disposable filter made of PTFE and having a pore size of 0.45 μm. The results are shown in Table 2.

### Method for Calculating Proportion of Component Having Weight-Average Molecular Weight of 25×10⁴ or Less in Poly(3-hydroxyalkanoate) Resin after Compounding

The abscissa and ordinate of the molecular weight distribution obtained by the above GPC analysis were converted into the logarithm of weight-average molecular weight and the cumulative percentage (%), respectively, to create a cumulative weight molecular weight distribution, from which the value of the cumulative percentage (%) at the weight-average molecular weight of 25×10⁴ (logarithmic value=5.4) was read as the proportion (wt %) of the component having a weight molecular weight of 25×10⁴ or less (see FIG. 1). The weight-average molecular weight region up to 1000 was excluded to eliminate the influence of other components such as additives. The results are shown in Table 2.

### Method for Evaluating Tube Productivity

The cylinder temperature and die temperature of a 50-mm-diameter single-screw extruder, to which an annular die (outer diameter=15 mm, inner diameter=13.5 mm) was coupled, were set to 165° C. Resin composition pellets were placed into the extruder and extruded into a tube. The extruded tube was passed through a 40° C. water bath located 100 mm away from the annular die and was then hauled off by a haul-off machine. To evaluate the moldability, the screw rotational speed and the haul-off speed were changed arbitrarily, and the maximum haul-off speed at which a tube having an outer diameter of 6 mm and a wall thickness of 0.2 mm was able to be produced was used as a measure of tube productivity.

### Method for Evaluating Tube Strength

The resin tube produced was cut into a 40-mm-long piece for use as a test specimen. The test specimen was placed on a plate made up of a 3-mm-thick SUS plate and a 2-mm-thick rubber sheet laid on the SUS plate. A given weight was dropped freely from a given height onto the test specimen. The resulting fracture was used as a basis to estimate the drop height at which the probability of fracture would be 50%, and the 50% fracture energy was calculated based on the estimated drop height. The weight was in the shape of a rectangular parallelepiped, and dropped in such a manner that the weight came into parallel contact with the straw.

### Example 1

An amount of 1.00 kg of PHA-1, 3.25 kg of PHA-2, and 0.75 kg of PHA-4 were blended to give resin proportions shown in Table 1. To the blend were added 500 g of Additive-1, 25 g of Additive-2, and 25 g of Additive-3, and the blend and the additives were dry-blended. The resulting resin material (resin mixture) was placed into and extruded by a 26-mm-diameter corotating twin-screw extruder whose cylinder temperature and die temperature were set to 150° C. The extruded resin material in the shape of a strand was passed through a water bath filled with 40° C. hot water to solidify the strand, which was cut by a pelletizer to obtain resin composition pellets.

The cylinder temperature and die temperature of a 50-mm-diameter single-screw extruder, to which an annular die (outer diameter=15 mm, inner diameter=13.5 mm) was coupled, were set to 165° C. The resin composition pellets were placed into the extruder and extruded into a tube. The extruded tube was passed through a 40° C. water bath located 100 mm away from the annular die and was then hauled off by a haul-off machine. A resin tube having an outer diameter of 6 mm and a wall thickness of 0.2 mm was successfully obtained at a maximum haul-off speed of 40 m/min.

The tube obtained was aged at 25° C. and 60% RH and then cut into a 40-mm-long piece for use as a test specimen for tube strength evaluation. This test specimen was used to calculate the 50% fracture energy as described above, and the 50% fracture energy was determined to be 1.02 J.

The evaluation results of tube productivity and tube strength are summarized in Table 2.

### Examples 2 to 4 and Comparative Examples 1 to 3

Resin composition pellets were produced in the same manner as in Example 1, except that the components and their proportions were changed as shown in Table 1, and evaluation procedures identical to those in Example 1 were conducted. The results are summarized in Table 2.

TABLE 1

| | Component (A) | | | | | | | |
|---|---|---|---|---|---|---|---|---|
| | First component | | | | Second component | | | |
| | | | Weight- | | | | Weight- | |
| | | Average | average | | | Average | average | |
| | | comonomer | molecular | | | comonomer | molecular | |
| | | content | weight ×10⁴ | Content | | content | weight ×10⁴ | Content |
| | Component | (mol %) | (g/mol) | (wt %) | Component | (mol %) | (g/mol) | (wt %) |
| Ex. 1 | PHA-1 | 4.6 | 25 | 20 | PHA-2 | 4.6 | 55 | 65 |
| Ex. 2 | PHA-1 | 4.6 | 25 | 30 | PHA-2 | 4.6 | 55 | 55 |
| Ex. 3 | PHA-3 | 4.6 | 15 | 25 | PHA-2 | 4.6 | 55 | 60 |
| Ex. 4 | PHA-1 | 4.6 | 25 | 25 | PHA-2 | 4.6 | 55 | 55 |
| Comp. 1 | PHA-5 | 6 | 60 | 85 | — | — | — | — |
| Comp. 2 | PHA-1 | 4.6 | 25 | 10 | PHA-2 | 4.6 | 55 | 75 |
| Comp. 3 | PHA-1 | 4.6 | 25 | 50 | PHA-2 | 4.6 | 55 | 30 |

| | Component (B) | | | | | |
|---|---|---|---|---|---|---|
| | | | Weight- | | | |
| | | Average | average | | Other components | |
| | | comonomer | molecular | | | Amount per 100 |
| | | content | weight ×10⁴ | Content | | parts of P3HA |
| | Component | (mol %) | (g/mol) | (wt %) | Component | (parts by weight) |
| Ex. 1 | PHA-4 | 28.2 | 66 | 15 | — | — |
| Ex. 2 | PHA-4 | 28.2 | 66 | 15 | — | — |
| Ex. 3 | PHA-4 | 28.2 | 66 | 15 | — | — |
| Ex. 4 | PHA-4 | 28.2 | 66 | 20 | Talc | 20 |
| Comp. 1 | PHA-4 | 28.2 | 66 | 15 | — | — |
| Comp. 2 | PHA-4 | 28.2 | 66 | 15 | — | — |
| Comp. 3 | PHA-4 | 28.2 | 66 | 20 | — | — |

TABLE 2

| | | Proportion of | | |
|---|---|---|---|---|
| | Weight-average | component having | | |
| | molecular | weight-average | | |
| | weight | molecular weight | | |
| | of total | of 25 × 10⁴ or | Tube | Tube |
| | P3HA × 10⁴ | less in total | productivity | strength |
| | (g/mol) | P3HA (wt %) | (m/min) | (J) |
| Ex. 1 | 45 | 20 | 40 | 1.02 |
| Ex. 2 | 40 | 30 | 45 | 1.33 |
| Ex. 3 | 38 | 25 | 55 | 2.87 |
| Ex. 4 | 41 | 20 | 39 | 2.74 |
| Comp. 1 | 63 | 0 | 23 | 0.41 |
| Comp. 2 | 50 | 10 | 30 | 0.55 |
| Comp. 3 | 29 | 50 | Molding | — |
| | | | failed | |

Table 2 reveals the following findings. In Examples 1 to 4, the resin tube productivity was high, and high-speed molding was successfully performed. Additionally, the obtained resin tubes had high strength.

In Comparative Examples 1 and 2, the resin tube productivity was lower than in Examples, and the obtained resin tubes had low strength. In Comparative Example 3, molding under the evaluation conditions failed to produce a resin tube.

1. A resin tube comprising a poly(3-hydroxyalkanoate) resin, wherein
the poly(3-hydroxyalkanoate) resin comprises at least one copolymer of 3-hydroxybutyrate units and other hydroxyalkanoate units,
a polystyrene-equivalent weight-average molecular weight of the poly(3-hydroxyalkanoate) resin, as measured by gel permeation chromatography using a chloroform solvent, is from 30×10⁴ to 50×10⁴, and
in a molecular weight distribution of the poly(3-hydroxyalkanoate) resin, a proportion of a component having a weight-average molecular weight of 25×10⁴ or less is from 15 to 40 wt %.

2. The resin tube according to claim 1, wherein the copolymer of 3-hydroxybutyrate units and other hydroxyalkanoate units is at least one selected from the group consisting of poly(3-hydroxybutyrate-co-3-hydroxyvalerate), poly(3-hydroxybutyrate-co-3-hydroxyvalerate-co-3-hydroxyhexanoate), poly(3-hydroxybutyrate-co-3-hydroxyhexanoate), and poly(3-hydroxybutyrate-co-4-hydroxybutyrate).

3. The resin tube according to claim 1, wherein the copolymer of 3-hydroxybutyrate units and other hydroxyalkanoate units is poly(3-hydroxybutyrate-co-3-hydroxyhexanoate).

4. The resin tube according to claim 1, wherein the poly(3-hydroxyalkanoate) resin comprises:
a copolymer (A) which is a copolymer of 3-hydroxybutyrate units and other hydroxyalkanoate units and in which a content of the other hydroxyalkanoate units is from 1 to 6 mol %; and
a copolymer (B) which is a copolymer of 3-hydroxybutyrate units and other hydroxyalkanoate units and in which a content of the other hydroxyalkanoate units is at least 24 mol %.

5. The resin tube according to claim 4, wherein a weight-average molecular weight of the copolymer (B) is from 40×10⁴ to 80×10⁴.

6. The resin tube according to claim 1, wherein an amount of a resin other than the poly(3-hydroxyalkanoate) resin is from 0 to 35 parts by weight per 100 parts by weight of the poly(3-hydroxyalkanoate) resin.

7. The resin tube according to claim 1, further comprising a nucleating agent and/or a lubricant.

8. The resin tube according to claim 1, further comprising 1 to 30 parts by weight of an inorganic filler per 100 parts by weight of a total resin component comprising the poly(3-hydroxyalkanoate) resin.

9. The resin tube according to claim 1, wherein a wall thickness of the resin tube is from 0.01 to 0.6 mm.

10. The resin tube according to claim 1, wherein a wall thickness of the resin tube is from 0.7 to 10 mm.

11. The resin tube according to claim 1, wherein the poly(3-hydroxyalkanoate) resin comprises a poly(3-hydroxyalkanoate) resin having a weight-average molecular weight of from 40×10⁴ to 80×10⁴ and a poly(3-hydroxyalkanoate) resin having a weight-average molecular weight of from 10×10⁴ to 40×10⁴.

12. The resin tube according to claim 1, wherein an average content ratio of 3-hydroxybutyrate units to the other hydroxyalkanoate units, 3-hydroxybutyrate units/other hydroxyalkanoate units, in the poly(3-hydroxyalkanoate) resin is from 95/5 to 82/18 mol %/mol%.

13. The resin tube according to claim 1, wherein the polystyrene-equivalent weight-average molecular weight of the poly(3-hydroxyalkanoate) resin is from 35×10⁴ to 48×10⁴.

14. The resin tube according to claim 1, wherein the proportion of the component having a weight-average molecular weight of 25×10⁴ or less is from 18 to 35 wt %.

15. The resin tube according to claim 1, wherein the poly(3-hydroxyalkanoate) resin comprises a poly(3-hydroxyalkanoate) resin having a weight-average molecular weight of from 45×10⁴ to 75×10⁴ and a poly(3-hydroxyalkanoate) resin having a weight-average molecular weight of from 12×10⁴ to 35×10⁴.

16. The resin tube according to claim 11, wherein a ratio of the poly(3-hydroxyalkanoate) resin having the weight-average molecular weight of from 40×10⁴ to 80×10⁴ to the poly(3-hydroxyalkanoate) resin having the weight-average molecular weight of from 10×10⁴ to 40×10⁴ is from 50:50 to 95:5.

17. The resin tube according to claim 4, wherein
the content of the other hydroxyalkanoate units in the copolymer (A) is from 2 to 6 mol %; and
the content of the other hydroxyalkanoate units in the copolymer (B) is from 24 to 99 mol %.

18. The resin tube according to claim 17, wherein the content of the other hydroxyalkanoate units in the copolymer (B) is from 24 to 50 mol %.

19. The resin tube according to claim 4, wherein a weight-average molecular weight of the copolymer (B) is from 45×10⁴ to 75×10⁴.

20. The resin tube according to claim 4, wherein a content of the copolymer (A) is from 60 to 97 wt % and a content of the copolymer (B) is from 3 to 40 wt %, based on a total of the copolymers A and B in the poly(3-hydroxyalkanoate) resin.
